(19) United States
(12) Patent Application Publication
(10) Pub. No.: US 2001/0038777 A1
(43) Pub. Date: Nov. 8, 2001

(54) Trailer chassis for containerized cargo

(76) Inventor: Harry Cassell JR., Pennsauken, NJ (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/846,111

(22) Filed: May 1, 2001

Related U.S. Application Data
(60) Provisional application No. 60/201,513, filed on May 3, 2000.

(51) Int. Cl. B60P 1/64

(52) U.S. Cl. 410/84

(57) ABSTRACT

A trailer chassis adapted to receive intermodal containers, wherein the trailer includes openings in the trailer bed to allow couplers which remain attached to a container to be accommodated by the trailer, and where preferably access can be gained to the couplers to allow their removal from the intermodal container after the container is placed on the trailer. The trailer also incorporates structures that guide a container being lowered by a crane into correct alignment with the trailer, reducing the potential for misalignment between the container and the trailer.

### CROSS-REFERENCE TO RELATED APPLICATION

The benefit of the filing date of U.S. provisional patent application Serial No. 60/201,513, filed May 3, 2000, is hereby claimed pursuant to 35 U.S.C. 119(e).

### FIELD OF THE INVENTION

This invention relates generally to a trailer chassis for moving containerized cargo in a loading area, and more particularly to a trailer chassis incorporating recesses to allow container couplers to remain on the container while the container is loaded onto a trailer.

### BACKGROUND OF THE INVENTION

In order to simplify the transportation of cargo from one location to another, standardized cargo containers 10 (shown in FIG. 1) have been developed. These containers can be carried aboard a ship, on rail cars, or on truck trailers. A single container 10 can be packed at its sending point, and then moved through several modes of transportation without needing to be re-packed into containers suited for the individual transportation modes. Typical containers are twenty feet or forty feet in length, and have corner castings 12 at each corner of the container 10. The corner castings 12 are hollow, and have slots 14 cut through their exterior faces 16.

As shown in FIG. 2, one type of standardized containers 10 have provisions for attaching couplers 18, commonly called rotary-locks or twist-locks which interconnect containers to each other. The couplers 18 include a shoulder 20 and a rotating head 22. In the unlocked position, the head 22 is parallel (as shown) to the long axis of the shoulder 20, allowing the head 22 and shoulder 20 to be inserted through a slot 14 in a corner casting 12. The height of the shoulder 20 approximates the thickness of the exterior face 16 of the corner castings. Once the head 22 and shoulder 20 are inserted into the corner casting 12, the head 22 is rotated and locked into position to prevent withdrawal of the shoulder 20 from the slot 14 in the corner casting 12. Each coupler 18 has a pair of shoulders 20 mounted on opposite sides of a central block 24 which houses locking and release mechanisms for the heads 22. Couplers 18 of this type are shown in U.S. Pat. Nos. 4,082,052, 4,196,673, and 5,548,877, herein incorporated by reference. These couplers 18 allow containers 10 to be stacked, such as on the deck of a ship, without requiring extra structure to restrain the containers 10. Since the containers 10 are locked to each other by the couplers 18, secondary structure is not required to secure the containers 10.

These couplers 18 are releasable. In practice, however, the coupler 18 remains protruding when containers are de-coupled. In particular, when vertically stacked containers 10 are separated, the coupler 18 remains attached to the underside of the upper container until it is released and removed.

Since standardized containers 10 are interchangeable with each another, standardized equipment and procedures can be used to greatly reduce the amount of time required to load and unload a ship. Any reduction in the time required to load and unload a ship yields benefits in several areas, including optimizing the return of capital investment in the ship, as the ship can spend less time in port.

The present procedure for unloading standardized or intermodal containers 10 requires the use of a crane 26, which picks the container from the deck of a ship, and transfers the container to a trailer chassis (not shown) adapted for moving the containers within the shipyard. Present trailers use a central beam on which the containers rest, with a bar across the front of the trailer to restrain forward motion of a container on the trailer. At the rear corners of the trailer are a pair of connectors positioned to engage slots in the rear corners of the container. These are the same slots used for mounting the couplers 18, and as such, any couplers 18 have to be removed from the corner castings 12 before the container 10 can be mounted to the trailer.

Because these couplers must be removed, a crane operator is required to lower the container 10 away from the trailer so that longshoreman can first remove the couplers 18 from the container 10. Once the couplers 18 have been removed, the container is again raised, and then repositioned over the trailer onto which it is being loaded. This additional cycle required to remove the couplers 18 reduces the rate at which containers can be removed from a ship and transferred to a trailer. Additionally, the crane operator must carefully position the container over the trailer to line up the connectors with the corner casting 12. Frequently, a first attempt to lower the container onto the connectors is ineffective, and the container 10 must be re-raised, and a second attempt made to line up the connectors. The additional cycles required to remove the couplers 18, and to re-raise the container when a first placement operation is unsuccessful, reducing the rate at which containers can be off-loaded from a ship.

### SUMMARY OF THE INVENTION

In its broadest aspect, the invention is a trailer adapted to receive intermodal containers. The trailer includes a bed which incorporates openings at the corners of the bed to allow a container, from which locks and couplers protrude, to be placed onto the trailer without first having to remove the couplers. In a preferred embodiment, the trailer bed includes shelves which are positioned under the front, rear, and side edges of the container to support the container on the trailer. The shelves do not extend for the full length of the container, but rather stop short of each corner, so that an opening exists underneath the container in the area of the corner castings, allowing the locks and couplers to be accessed from below the trailer and removed after the container has been placed on the trailer. The trailer further includes structures that act as guides to assist in positioning the container on the trailer, as well as restrain a container on the trailer from shifting while the trailer is moving.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 is a perspective view of the underside of a container, showing the location of the corner castings.

FIG. 2 is a perspective view of a corner of a container, showing a coupler protruding from a corner casting.

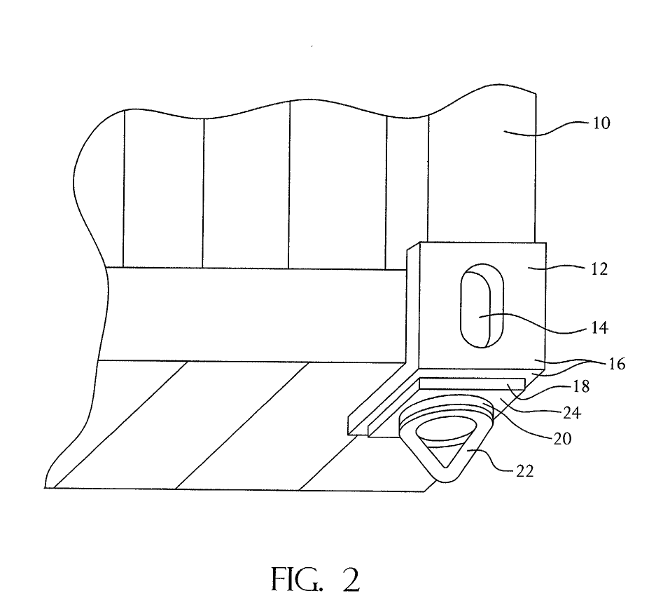

FIG. 3 is top plan view of a trailer chassis according to the present invention.

FIG. 4 is a cross-sectional view looking from the back of a trailer according to the present invention.

FIG. 5 is a partial perspective view of a rear corner of a trailer according to the present invention.

### DESCRIPTION OF THE INVENTION

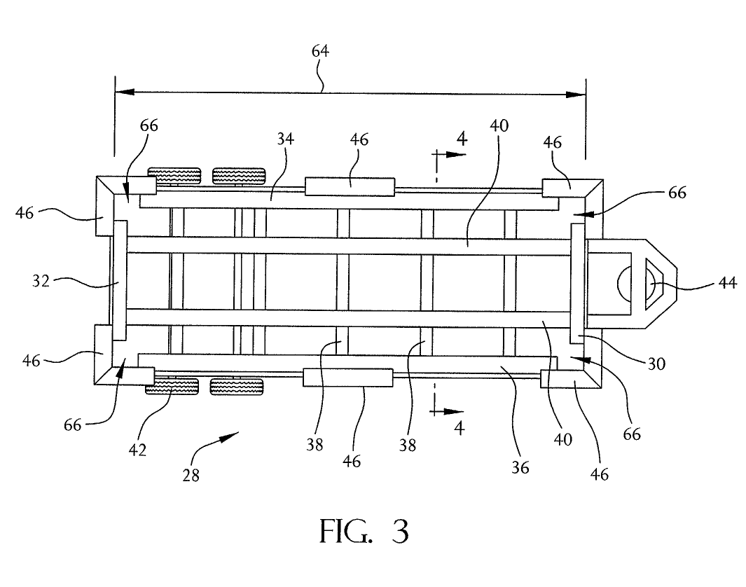

The invention will now be described with reference to the drawings wherein like numerals indicate like elements. Referring particularly to FIG. 3, a preferred embodiment of the trailer is shown wherein the trailer bed comprises structural steel framing having front 30, rear 32, left 34, and right 36 support beams. The left 34 and right 36 beams are mounted on ribs 38, which rest on a pair of frame rails 40. The frame rails 40 interconnect rear wheels 42 with a front hitch 44 for attaching the trailer 28 to a tractor (not shown). The front 30 and rear 32 beams rest on short ribs 38, which in turn rest on the frame rails 40.

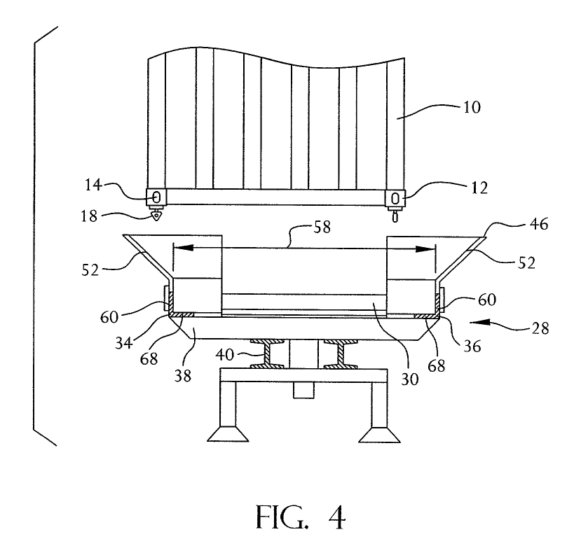

At four corner locations and two middle positions, structures, that in one embodiment are guides 46, are used to direct a descending container 10 into correct alignment with the front 30, rear 32, left 34 and right 36 beams (hereafter collectively referred to as the support beams.) As shown in FIG. 4, the guides 46 each have an angled face 52 which urges a container 10 which is descending off-centered into correct alignment with the left 34 and right 36 beams. Comer guides 46, having angled faces 52 along the front and rear edge of the trailer 28 likewise urge a descending container 10 into correct front/rear alignment with the trailer 28.

The left 34 and right 36 beams are formed from L-shaped structural members. The left 34 and right 36 side beams rest on the ribs 38, transferring the weight of a container 10 on the trailer onto the frame rails 40. The front 30 and rear 32 beams also rest on ribs 38 which provide structural support.

As shown in FIG. 3, the rear 32 beam does not extend for the full width of a container 10. Adjacent to each corner 54, the rear 32 beam is cut back so that no structure is located below the portion of a container 10 at which the corner castings 12 would be located. The rib 38 supporting the rear 32 beam is likewise limited as to width so that it does not block the underside of the container 10 in the area of the corner castings 12. Although the rear section of the trailer 28 is described above, the front end of the trailer 28 is similar to the rear. The left and right side beams are likewise cut short from the corners to allow access to the bottom of the container 10 while the container 10 rests on the trailer 28.

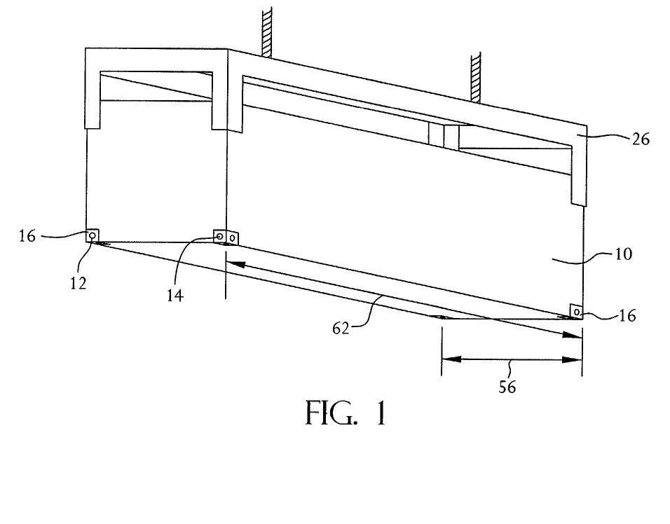

FIG. 4 illustrates the relation between the width 56 of the container 10 and the distance 58 between the vertical legs 60 of the left 34 and right 36 beams. The distance 58 between the right 36 and left 34 beams of necessity must be slightly greater than the width 56 of the container 10 to allow the container to nest between the vertical legs 60 of the beams. This relation also exists regarding the length 62 of the container 10. The distance 64 (shown in FIG. 3) between the vertical legs 60 of the front 30 and rear 32 beams must also be slightly greater than the length 62 of a container 10 (shown in FIG. 1). Although some clearance between the container 10 and the vertical legs 60 is desired, minimizing the amount of such clearance will also reduce the amount of shifting of the container 10 which can occur during movement of the trailer 28 on which the container 10 rests.

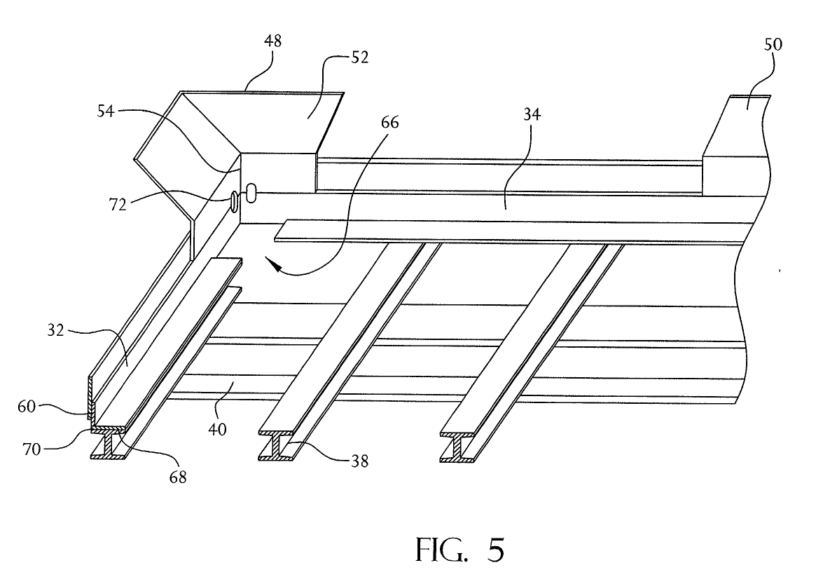

As shown in FIG. 5, the openings 66 located below the position of corner castings can also be formed by removing a section of the bottom leg 68 of the L-shaped structural member 70 from which the support beams are formed. By removing the bottom leg 60 in this area, the vertical legs 60 of the support members can be retained and joined at the corners 54 to provide support for the corner guides 48.

As shown in FIG. 5, provisions can be included to secure a container 10 to the trailer 28 through the corner castings 12. Apertures formed, in a preferred embodiment as retainer slots 72 can be cut through the vertical legs 60 of the support members, and through the corner guides 48 if required, to allow locks 74 to be installed to prevent vertical motion of a container 10 relative to the trailer 28. A modified rotary lock (not shown), having a taller shoulder to accommodate the additional thickness of the support members, can be engaged though the retainer slots 72 in the support members and the corner castings, with a rotatable head being employed to retain the lock to the trailer and container.

From the foregoing description it will be apparent that the invention described herein provides a simple yet effective trailer 28 which allows intermodal containers 10 from which couplers 18 protrude to be placed on the trailer 28 without requiring an intermediate step to first remove the couplers 18. Furthermore, the trailer 28 of the present invention reduces the effort required to place an intermodal container 10 onto the trailer 28 by incorporating guides 46 which urge a descending container 10 into the correct alignment with the trailer 28. As will be apparent to those familiar with the art, the invention may be embodied in other specific forms without departing from the spirit or essential characteristics thereof. The embodiment disclosed is therefore to be considered in all respects as illustrative rather than restrictive, the scope of the invention being indicated by the appended claims.

What is claimed is:

1. A trailer adapted to receive intermodal containers having locks and couplers, the trailer comprising:
a bed having a plurality of openings positioned to receive the coupler when the container is lowered onto the bed;
the openings being adapted so that the coupler may be accessed while the container is on the bed.

2. A trailer as in claim 1, wherein the bed includes a structure to guide the container into alignment with the bed as it is being lowered into position where the couplers extend through the openings.

3. A trailer as in claim 1, further comprising apertures adjacent the openings to allow access to container locks.

4. A trailer as in claim 2, further comprising apertures adjacent the openings to allow access to container locks.

5. A trailer adopted to receive intermodal containers having locks and couplers, the trailer comprising:
a bed having a structural steel frame and a plurality of openings positioned to receive the coupler when the container is lowered onto the bed;
the bed including a structure to guide the container into alignment with the bed as it is being lowered into position where the couplers are through the openings.

6. A trailer as in claim 5, further comprising apertures adjacent the openings to allow access to container locks.

7. A trailer as in claim 5, wherein the structural steel frame comprises:
a pair of frame rails extending from the rear of the bed to the front of the bed;
a plurality of ribs supported by the frame rails;
the ribs being perpendicularly disposed in relation to the frame rails;
a front, rear, left, and right support beam supported by the ribs;
the support beams arranged to accept a container while providing access to the container locks and couplers.
